(19) United States
(12) Patent Application Publication
(10) Pub. No.: US 2025/0168595 A1
(43) Pub. Date: May 22, 2025

(54) GREENHOUSE GAS ESTIMATION USING CELLULAR NETWORKS

(71) Applicant: T-MOBILE INNOVATIONS LLC, Overland Park, KS (US)

(72) Inventors: Sharath Somashekar, Overland Park, KS (US); Shruthi Ramakrishna, Overland Park, KS (US)

(21) Appl. No.: 18/514,695

(22) Filed: Nov. 20, 2023

(51) Int. Cl. H04W 4/029; G06Q 50/40

(52) U.S. Cl. CPC H04W 4/029; G06Q 50/40

(57) ABSTRACT

Systems and methods are provided for using a telecommunications network to estimate a total number of vehicles in a predetermined place at a predetermined time. Based on the total number of vehicles, the network can estimate greenhouse gas emissions for a particular area in real-time.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for estimating greenhouse gas emissions. More particularly, in aspects set forth herein, systems and methods enable detection of vehicles in a particular area utilizing the radio access network (RAN) in real-time. Vehicle traffic in particular areas is estimated to produce approximately 30-40% of total US emissions and there is an urgent need to identify a solution to aid the decrease of greenhouse gas emissions.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached figures, which are intended to be exemplary and non-limiting, wherein:

FIG. 1 depicts a diagram of an exemplary computing environment suitable for use in implementations of the present disclosure;

FIG. 2 illustrates a diagram of an exemplary network environment with one base station in which implementations of the present disclosure may be employed;

FIG. 3 depicts a right side elevation view of a diagram of an exemplary network environment with two base stations in which implementations of the present disclosure may be employed;

FIG. 4 depicts a top view of examples in which implementation of the present disclosure may be employed; and

FIG. 5 depicts a flow diagram of an exemplary method for a telecommunications network to estimate greenhouse gas emission in a predetermined area in real-time, in accordance with implementations of the present disclosure.

### DETAILED DESCRIPTION

The subject matter in aspects is provided with specificity herein to meet statutory requirements. However, the description itself is not intended to limit the scope of this patent. Rather, it is contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

By way of background, greenhouse gas emissions from vehicle traffic are typically estimated using a combination of direct measurements, models, and data collection. The most basic method involves collecting data on the amount of fuel consumed. Because the carbon content of gasoline, diesel, and other transportation fuels is generally consistent, traditionally a person can calculate carbon dioxide (CO2) emissions by multiplying the volume of fuel burned by the carbon content of that fuel. Emissions of other greenhouse gases, such as methane (CH4) and nitrous oxide (N2O), are much lower for road transportation and can be estimated based on the type of vehicle its emission controls, and the fuel it uses. Another technique to estimate greenhouse gas emissions is by using a remote sensor device that is placed alongside the road and can measure emissions directly from the passing vehicles. These conventional methods used to measure greenhouse gas emissions require expensive and extensive sensors, particularly in urban and suburban areas.

Aspects provided herein utilize the RAN to estimate a number of vehicles operating in a particular area. Assuming that the vast majority of vehicles have an active user equipment (UE) inside the vehicle, a multi-tier estimating solution can be utilized: (1) newer cars with a subscriber identity module (SIM) card can report their operation and make/model to the network; (2) UEs that are connected to a software platform that integrates UEs into a vehicle's infotainment system (e.g., Android Auto™ or Apple CarPlay™) or a vehicle entertainment Bluetooth device and can report they are connected to a vehicle; and/or (3) other UEs can be determined to be in a vehicle based on certain thresholds (e.g., velocity, location, duration, etc.). By aggregating and de-duplicating the vehicle UE data, the network can achieve an accurate estimation of how many vehicles are operating in a particular location at a particular time. Additionally, using known make/model information in newer connected vehicles, and generic (i.e., average) information for older vehicles, greenhouse gas emissions for a particular area can be estimated based on the estimated number of vehicles in the particular area. Furthermore, a machine learned model, trained using measurement sensors near highways, can also be implemented to refine the estimation.

Unlike conventional solutions, aspects herein are related to determining, using the telecommunications network (i.e., RAN), how many vehicles are moving in a particular location at a particular time. In aspects, the telecommunications network receives an indication that a UE is moving to act as a trigger to start collecting information in real-time. However, just because a UE is moving does not mean the user is in a vehicle. The user could have a UE on their person while walking, riding a bike, and the like. In order to eliminate non-CO2 emitting activity from the data being collected, the data collection can be based on a determination that a UE is moving above a predetermined threshold (e.g., above ten miles per hour). At this velocity, it can be assumed that the UE is moving in a vehicle and the user is participating in CO2 emitting activity. Based on a determination that the UE is moving at a velocity above a predetermined threshold, an estimation can be made for CO2 emissions. The UE can send its location and velocity information to the telecommunications network and once the UE is determined to be moving at a velocity above the predetermined threshold, it can continue to send its location and velocity information to the telecommunications network continuously until movement above the predetermined threshold is no longer detected. For example, the UE could send location and velocity information every 30 seconds, 1 minute, 5 minutes, 10 minutes, 15 minutes, 30 minutes, or any other configurable interval of time. Alternatively, to conserve battery power, the UE could collect and hold its location and velocity information during its commute and send the information all at once as a “batch” once the commute is finished. These specific times are provided for exemplary purposes only, and not for limitation.

In alternative embodiments, the UE may be in a vehicle that has come to rest for a brief period of time but is still producing CO2 (e.g., stopped at a traffic light). Because an idling vehicle produces a significant quantity of CO2 emissions, the UE may continue to send its location and velocity information to the telecommunications network until movement of the UE has not been detected for a predetermined period of time (e.g., 10 minutes). This way, the CO2 tracking can continue while a vehicle is participating in CO2 emitting activity (e.g., driving, stopped at a traffic light, slow moving traffic, etc.). In aspects, the telecommunications network can cross-reference the make and model information of the vehicle associated with the UE with a table of pollution measurements mapping the velocity to the make and model of the vehicle. In examples, a first table can include pollution measurements of moving vehicles and a second table can include pollution measurements of idling vehicles to receive an accurate representation of CO2 emission based on velocity. In alternative embodiments, a traffic light may have a static pollution measuring sensor that can be utilized to gather CO2 measurements.

As used herein, the term “cell site,” may include an “access point,” “node,” or “base station” refer to a centralized component or system of components that is configured to wirelessly communicate (receive and/or transmit signals) with a plurality of stations (i.e., wireless communication devices, also referred to herein as user equipment (UE(s))) in a geographic service area. A cell site suitable for use with the present disclosure may be terrestrial (e.g., a fixed/non-mobile form such as a macro cell site or a utility-mounted small cell) or may be extra-terrestrial (e.g., an airborne or satellite form such as an airship or a satellite).

The terms “user device,” “user equipment,” “UE,” “mobile device,” “mobile handset,” and “mobile transmitting element” all describe a mobile station and may be used interchangeably in this description.

The terms “GPS,” “global positioning system,” and “location information” may be used interchangeably to describe methods to determine or calculate exact location. Another such method used to calculate location information, may involve utilizing the serving beam, the OTDOA (observed time difference of Arrival) techniques, as well of AoA (Angle of Arrival) of UE signals to precisely calculate the position of a user utilizing solely the telecommunication network. Certain terminology may be used to differentiate access points and/or antenna arrays from one another; for example, a combination access point may be used to describe an access point having a primary antenna array and a redundant antenna array that have different orientations (i.e., configured to serve different geographic areas), distinguished from a traditional access point which may be used to describe an access point comprising a single antenna array used to communicate to a single geographic area.

Accordingly, a first aspect of the present disclosure is directed to a system for measuring greenhouse gas emissions utilizing a telecommunications network, the system comprising one or more processors and one or more computer-readable media storing computer-usable instructions. When executed by the one or more processors, the instructions cause the one or more processors to receive an indication that a user equipment (UE) has registered with a base station within the telecommunications network. The system determines a velocity of the UE and based on a determination that the UE's velocity is above a predetermined threshold, the system determines that the UE is traveling in a vehicle in a first location and can estimate a total number of vehicles in the first location.

A second aspect of the present disclosure is directed to a method for measuring greenhouse gas emissions in real-time utilizing a telecommunications network. The method comprises identifying a plurality of UE devices moving at a velocity above a predetermined threshold. Based on the velocity being above a predetermined threshold, the method determines that a plurality of UE devices is moving in the vehicle. The method can determine a total number of vehicles at a first location based on analyzing one or more occupancy criteria, wherein the one or more occupancy criteria comprises a velocity for each UE device of the plurality of UE devices. Based on the total number of vehicles, the method can estimate greenhouse gas emissions for the first location.

A third aspect of the present disclosure is directed to a system for measuring greenhouse gas emissions utilizing a telecommunications network, the system comprising one or more processors and one or more computer-readable media storing computer-usable instructions. When executed by the one or more processors, the instructions cause the one or more processors to identify a plurality of UE devices moving at a velocity above a predetermined threshold. Based on the velocity being above a predetermined threshold, the system determines that a plurality of UE devices is moving in the vehicle. The system can determine a total number of vehicles at a first location based on analyzing one or more occupancy criteria, wherein the one or more occupancy criteria comprises a velocity for each UE device of the plurality of UE devices. Based on the total number of vehicles, the system can estimate greenhouse gas emissions for the first location.

According to a final aspect of the technology described herein, a method is provided for measuring greenhouse gas emissions utilizing a user equipment (UE). The method comprises a UE registering with a base station and generating a first report with vehicle identifying information. The UE will hold the first report until identifying that the UE is moving at a first velocity that is above a certain threshold. Based on the UE moving at a first velocity that is above a certain threshold, the UE will generate a second report with information comprising the first velocity and communicate both the first report and the second report to the base station within a telecommunications network.

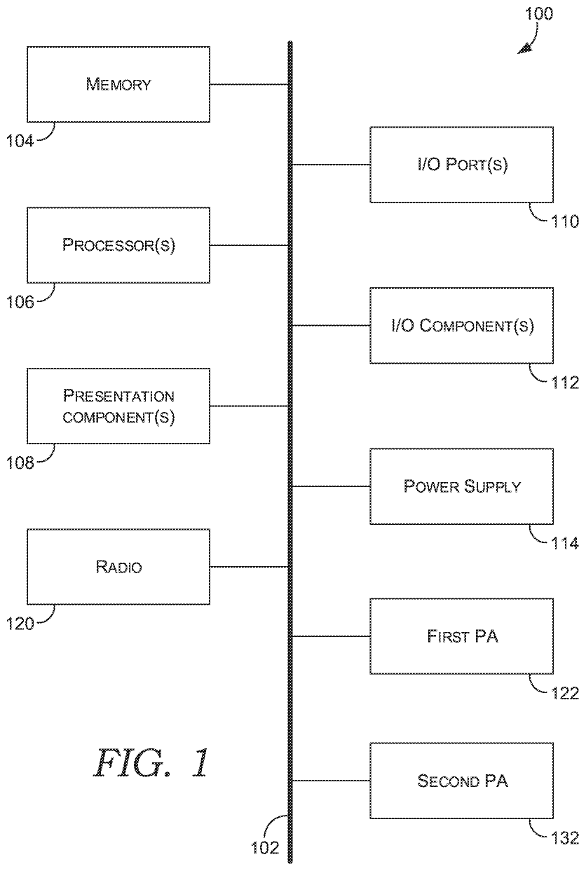

Referring to FIG. 1, a diagram is depicted of an exemplary computing environment suitable for use with implementations of the present disclosure. In particular, the exemplary computer environment is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 may be a UE, WCD, or other user device, capable of two-way wireless communications with an access point. Some non-limiting examples of the computing device 100 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

Radio 116 represents a radio that facilitates communication with a wireless telecommunications network. In aspects, the radio 116 utilizes one or more transmitters, receivers, and antennas to communicate with the wireless telecommunications network on a first downlink/uplink channel. Though only one radio is depicted in FIG. 1, it is expressly conceived that the computing device 100 may have more than one radio, and/or more than one transmitter, receiver, and antenna for the purposes of communicating with the wireless telecommunications network on multiple discrete downlink/uplink channels, at one or more wireless nodes. Illustrative wireless telecommunications technologies include 5G-NR, LTE, CDMA, GPRS, TDMA, GSM, and the like. Radio 116 might additionally or alternatively facilitate other types of wireless communications including Wi-Fi, WiMAX, LTE, 5G or other VoIP communications. As can be appreciated, in various embodiments, radio 116 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

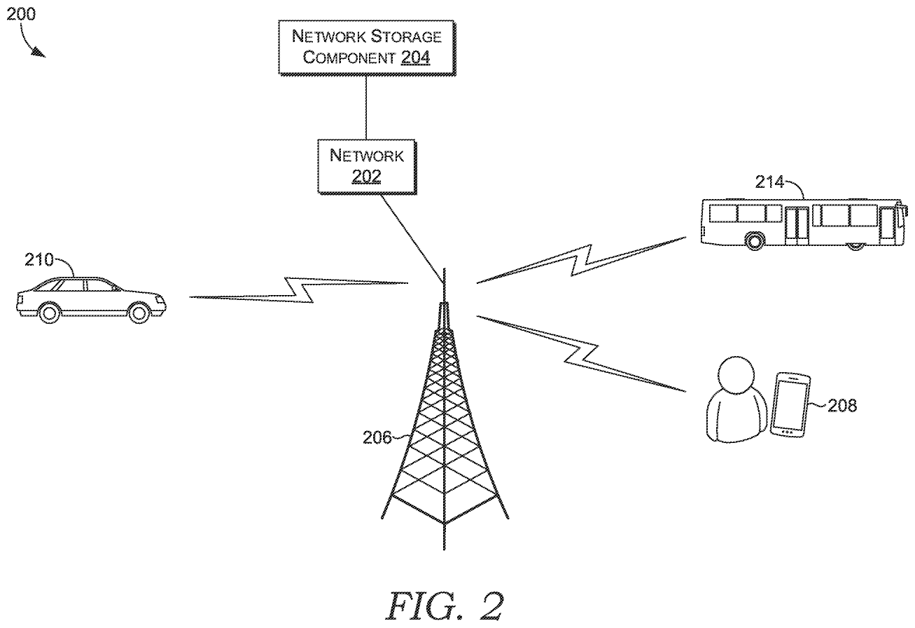

Turning now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 generally includes a cell site 206, a plurality of UEs (e.g., a user with a UE 208, a car 210, and a public transportation vehicle (i.e., bus 214)), and one or more components configured to wirelessly communicate between the plurality of UE's (i.e., 208, 210, and 214), and a network 202. Though illustrated as a macro site, the cell site 206 may be a macro cell, small cell, femto cell, pico cell, or any other suitably sized cell, as desired by a network carrier for communicating within a particular geographic area utilizing any range of frequencies for communication. In aspects, such as the one illustrated in FIG. 2, the cell site 206 may comprise one or more nodes (e.g., NodeB, eNodeB, ng-eNodeB, gNodeB, en-gNodeB, and the like) that are configured to communicate with the plurality of UEs (208, 210, and 214) in one or more discrete geographic areas using one or more antennas of an antenna array. In the aspect illustrated in FIG. 2, the cell site 206 provides a coverage to the plurality of UEs (208, 210, and 214). The car 210 and/or the bus 214 may be “connected cars/vehicles” that are equipped with technology that allows them to connect to cellular networks (e.g., the cars can include an onboard SIM card). Alternatively, the car 210 and/or the bus 214 may be vehicles that are not equipped with the capability to connect to cellular networks or do not have communication modules to interface with other devices or infrastructures, but rather a driver or a passenger of the vehicle has a UE (i.e., mobile device) on their person that is connected to the cellular network.

The network environment 200 may also include network storage component 204. Network storage component 204 may be used to store information associated with the plurality of UEs (208, 210, and 214), such as data collected from the plurality of UEs (208, 210, and 214) including velocity and location information. Conventionally, the plurality of UEs (208, 210, and 214) can utilize different sources of information to provide location information. One way the plurality of UEs (208, 210, and 214) can determine its location is via signals from a precise location service. In aspects, a precise location service may take the form of a satellite positioning system such as the global positioning system (GPS), GLONASS, and Galileo. In other examples, the plurality of UEs (208, 210, and 214) can determine its location based on the particular cell site (i.e., cell site 206) to which it is connected. In some aspects, the plurality of UEs (208, 210, and 214) are configured to communicate its location (i.e., location information) to the cell site 206.

The network environment 200 includes cell site 206 that is configured to wirelessly communicate with the plurality of UEs (208, 210, and 214), which may take the form of computing device 100 of FIG. 1. For the purpose of this disclosure, as mentioned herein, a UE includes any equipment that uses a chip card and a chip. Additionally, for the purpose of this disclosure, as mentioned herein, a cell site is used in its general sense, being defined as a station for transmitting and/or receiving RF signals; accordingly, the cell site 206 may take the form of a cellular node (e.g., eNodeB, gNodeB, etc.), or any other desirable emitter and/or receiver of signals that transmits and/or receives wireless signals to/from one or more UEs. A suitable cell site is not protocol-specific, but instead may be configured to communicate using any wireless telecommunication protocol that is compatible with the plurality of UEs (208, 210, and 214), such as 3G, 4G, 5G, 6G, 802.11x, or any other wireless standard. Cell sites consistent with the present disclosure may be configured to provide coverage to certain geographic service area, and will have one or more backhaul connections that connect it to a broader telecommunications and/or information network, such as the network 202, for the provision of telecommunication and/or information service(s) to the plurality of UEs (208, 210, and 214). As seen in the embodiment illustrated by FIG. 2, cell sites suitable for use in the present disclosure may be terrestrial, that is, they are coupled to the earth via a tower or some other structure, such as the cell site 206; alternatively, a suitable cell site may be extra-terrestrial, that is coupled to an aircraft or a satellite.

The network environment 200 comprises the network 202. The network 202 comprises any number of components that are generally configured to provide voice and/or data services to wireless communication devices, such as the plurality of UEs (208, 210, and 214), which are wirelessly connected to the cell site 206. For example, the network 202 may comprise one or more additional wireless cell sites, a core network, an IMS network, a PSTN network, or any number of servers, computer processing components, and the like. The network 202 may include access to the World Wide Web, internet, or any number of desirable data sources, which may be queried to fulfill requests from wireless communication devices that make requests via the cell site 206.

The network environment 200 comprises the plurality of UEs (208, 210, and 214), with which the cell site 206 connects to the network 202. Generally, the plurality of UEs (208, 210, and 214) may have any of the one or more aspects described with respect to the computing device 100 of FIG. 1. For the purposes of the present disclosure, the plurality of UEs (208, 210, and 214) may utilize a wireless data connection to communicate with the cell site 206.

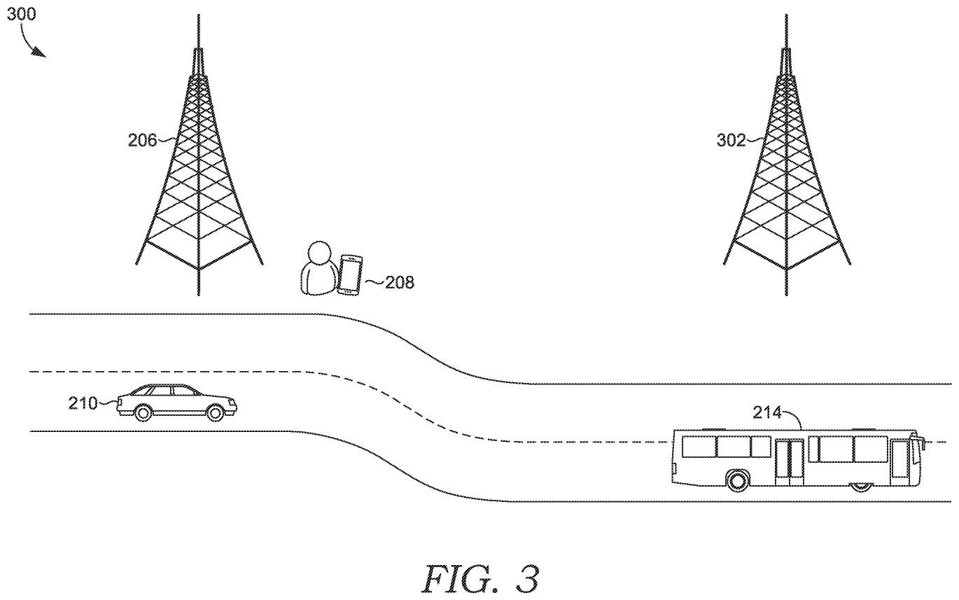

Turning now to FIG. 3, a right side elevation view of a diagram of an exemplary network environment with two base stations is depicted in which implementations of the present disclosure may be employed. In one or more embodiments, the exemplary network environment 300 represents or includes at least some of the functionality as described with respect to the network environment 200 of FIG. 2. In example aspects, the telecommunications network can receive an indication that a UE (e.g., user with UE 208, car 210, and/or bus 214) has registered with cell site 206 that is within the telecommunications network. In some embodiments, the car 210 and the bus 214 are driving down the road at a particular velocity. The telecommunications network can calculate or determine the velocity of the vehicles (i.e., the car 210 and the bus 214) based on using handover time between a UE registering with the cell site 206 and a second base station 302. For example, in cellular networks, when a UE (i.e., mobile phone or connected vehicles 210, 214) moves from the coverage area of the cell site 206 to the second base station 302, the telecommunications network can use the handover time (i.e., the duration it takes for the handover to be completed) and the distance between the two base stations to calculate the velocity of the vehicles. Because the telecommunications network knows the location of their base stations, the location of the vehicles can be documented as well. Alternatively, more direct methods (i.e., GPS) or by utilizing data from the accelerometers present within a UE or data fed from external accelerometers to the UE may be used to determine accurate location and velocity information of the vehicles. In other examples, the user with the UE 208 is not moving at a velocity that is above the predetermined threshold. In this case, the user with the UE 208 is determined to not be in a vehicle (i.e., not emitting CO2) and therefore, not included in the data collection.

Once it is determined that the car 210 and/or the bus 214 are moving at a velocity that is above a predetermined threshold (i.e., ten miles per hour), it is therefore determined that the car 210 and/or the bus 214 are participating in CO2 emitting activity. This determination can be used as a trigger to start measuring the CO2 emissions. In other words, the velocity and location information of the car 210 and/or bus 214 can be communicated to a data storage system within the network storage component (reference numeral 204 from FIG. 2) in the telecommunications network, where it can be maintained and stored indefinitely. The telecommunications network can access the data storage at any time to estimate the total number of vehicles in a predetermined area at a predetermined time. The total number of vehicles on the road can then be used to estimate greenhouse gas emissions. These estimations can be made in real-time or can be used over an extended period of time to see trends. In examples, the real-time greenhouse gas emissions could be used to create a visual aid or depiction (e.g., map, chart, etc.) to communicate the information to the general public or to scientists and engineers to help reduce greenhouse gas emissions.

In alternative aspects, the vehicle may not be connected to the network and the driver's UE (e.g., mobile device) would need to send the information to the network. For example, car 210 may not be connected to the network, but the driver of the car 210 has a UE (not shown) that is connected to the network. The driver's UE would register with the cell site 206 and generate a first report with vehicle identifying information to identify the make and model of car 210. The driver of car 210 may need to create a user profile with the telecommunications network that contains the vehicle identifying information so the driver's UE is associated with car 210. The driver's UE can hold the first report (i.e., not communicate the first report) until identifying that the driver is moving at a first velocity that is above a predetermined threshold (e.g., ten miles per hour). Next the driver's UE can generate a second report with information comprising the first velocity and a first location, and then the driver's UE could send both the first report and the second report to the cell site 206. As the driver's UE detects a change in velocity, it could generate a third report, a fourth report, and so on, wherein the ongoing reports include updated velocity and location information. For example, the driver's UE could send updated location and velocity information to the base station in real-time every 10 seconds, 30 seconds, 1 minute, 5 minutes, 10 minutes, 15 minutes, 30 minutes, or the like. Alternatively, to conserve battery power, the driver's UE could collect and hold its location and velocity information during its commute and send the information all at once as a “batch” once the duration of the commute is complete. These specific times are provided for exemplary purposes only, and not for limitation.

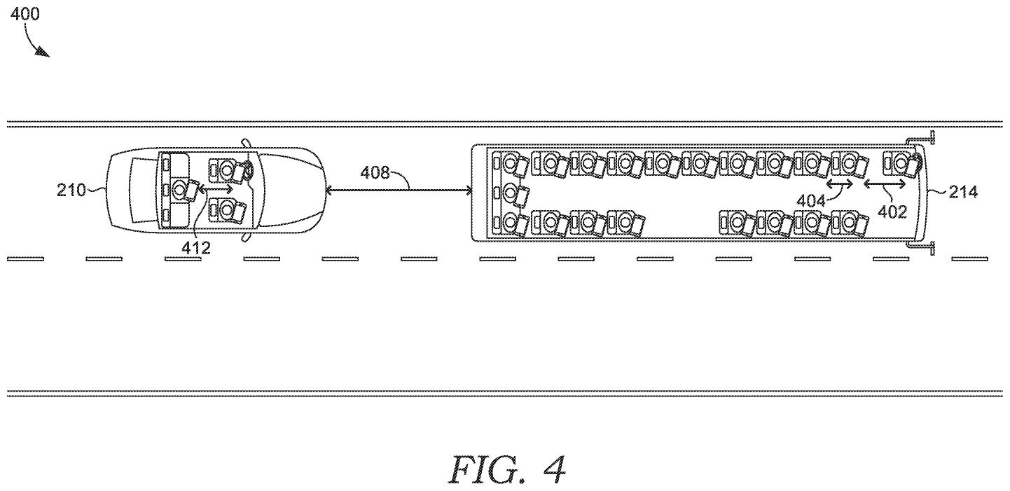

Turning to FIG. 4, a top view 400 of examples in which implementation of the present disclosure may be employed. The top view 400 may include some of the vehicles (i.e., car 210 and bus 214). In example aspects, the car 210 has three occupants and the bus 214 has twenty occupants. In top view 400, there are 23 total occupants who each have a UE (i.e., mobile device) that may be connected to the cellular network, and two total vehicles that may or may not be connected vehicles that can connect to the cellular network. In aspects, the vehicles 210 and 214 are both moving at a velocity above a predetermined threshold (e.g., ten miles per hour), which leads to a determination that they are both participating in CO2 emitting activity. In order for the telecommunications network to determine how many total vehicles are on the road in top view 400, based on the 23 occupants and two possible connected cars (altogether the “connected devices”), the telecommunications network can calculate one or more occupancy criteria (e.g., the distance between each UE device and velocity of the connected devices) to determine which occupants are commuting in the same vehicle to aggregate and de-duplicate the vehicle UE data. For example, first distance 408 shows that the car 210 and the bus 214 are spaced far enough apart that they are two separate vehicles, and therefore, the occupants inside of the car 210 and the bus 214 are not riding together. In other words, the distance between the UEs onboard the car 210 and the bus 214 are a distance from one another that is greater than a predetermined threshold. In addition to the first distance 408, the velocity of the occupants inside of car 210 and bus 214 are not traveling at the exact same velocity, meaning they are not all riding inside of a single vehicle; whereas all of the UEs onboard the bus 214 should be measuring at a velocity that is exactly the same for each UE. Additionally, we can also use distance to support a determination that UEs are onboard a single vehicle just as it was described above with respect to determining that UEs are not onboard a single vehicle. For instance, distances, such as second distance 402 and third distance 404, are spaced close together to show that the occupants are traveling in the same vehicle together (i.e., bus 214). In other words, the distance between the UEs onboard the bus 214 (i.e., second distance 402 and third distance 404) are a distance from one another that is less than a predetermined threshold. In addition to the second distance 402 and third distance 404, the occupants traveling in bus 214 are all maintaining their distance and traveling at the same velocity, meaning they are all in the same vehicle together. In car 210, the occupants traveling at the same velocity as each other and being spaced apart a fourth distance 412 that is less than a predetermined threshold also leads to a determination that the three occupants in car 210 are riding together in a single vehicle. By understanding which occupants with UEs (e.g., mobile devices) are traveling in the same vehicle, the telecommunications network can estimate the number of vehicles operating in a particular place at a particular time and are able to aggregate and de-duplicate the vehicle UE data. Furthermore, the telecommunications network can estimate which type of vehicle is on the road to estimate its CO2 emissions. For example, the bus 214 is estimated to have twenty occupants (this can be inferred either from make/model data received for the bus or an exact occupancy value provided from, for instance, a smart bus), so it can be assumed that bus 214 is some sort of public transportation vehicle and the CO2 emissions can be estimated based on a vehicle that particular size and type. Aspects herein can also determine a driver of a vehicle in some instances to identify separate vehicles. For example, a user profile associated with the UE of the driver of car 210 may identify the user as an employee of a public transportation service (e.g., taxi company). Similarly, a user profile of the UE of the driver of the bus 214 may identify that the individual is an employee of the bus company. When aggregated with the other information such as distance between UEs and similar velocities, a driver determination can further support a determination that vehicles are separate.

In some aspects, the car 210 and the bus 214 (the “vehicles”) may be connected to the telecommunications network themselves. When the vehicles 210 and 214 connect to the telecommunications network via its infotainment system (i.e., Android Auto™, Apple CarPlay™, Bluetooth, SIM card, UE connected directly to the vehicle, etc.), several pieces of information are exchanged between the vehicles 210/214 and the network (i.e., make and model of vehicles, location, etc.). In these example, the vehicles 210 and 214 themselves are connected to the network, so the occupants riding in the vehicles 210 and 214 do not need to provide any vehicle identifying information. Alternatively, the vehicles 210 and 214 may not be connected to the network themselves and the driver may need to submit the vehicle identifying information for their vehicle. In aspects, the telecommunications network may provide incentives (i.e., lower monthly bill) if the driver provides this vehicle identifying information.

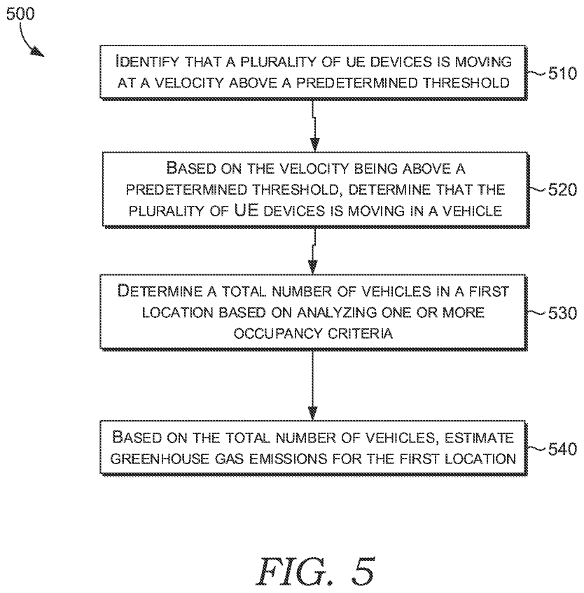

Turning now to FIG. 5, a flowchart is provided of a method 500 for estimating greenhouse gas emissions. Initially at block 510, the telecommunications network identifies that a plurality of UE devices is moving at a velocity above a predetermined threshold. At block 520, based on the velocity being above a predetermined threshold, the network determines that the plurality of UE devices is moving in a vehicle. At block 530, the network determines a total number of vehicles at a first location based on analyzing one or more occupancy criteria, wherein the one or more occupancy criteria comprises a velocity for each UE device of the plurality of UE devices. At block 540, based on the total number of vehicles, the network estimates greenhouse gas emissions for the first location.

In other aspects, a machine learned model (i.e., artificial intelligence (AI)), trained using measurement sensors near highways, can be implemented to refine the greenhouse gas estimation. The AI system can use a range of techniques, encompassing supervised, unsupervised, and semi-supervised learning. In aspects, this incorporates a multitude of algorithms, such as decision trees, neural networks, clustering methods, and the like. In example aspects, the AI system consists of several input and output points. These points, or nodes, represent specific data features, undergoing various mathematical processes. Certain components (i.e., accelerometers and sensors) provide these data features and form the AI's decision basis. Prior to feeding data in the AI's training mechanisms, a preprocessing phase refined the input. This phase can involve tasks such as data cleansing, normalization, and scaling, to ensure data consistency and quality.

The AI system can also undergo feature extraction processes, which streamline and simplify the cast amounts of input data. This extraction determines the most critical data aspects and ensure an efficient machine learned model performance. Several feature extraction methodologies may be used, ranging from statistical methods to algorithm-based techniques. These methodologies aim to present the most relevant data in an efficient manner for the AI to process. The preprocessing phase may also tackle challenges such as missing data. Another facet or preprocessing involves identifying and managing outliers to ensure they do not skew the AI's decision-making process. Another component of preprocessing is feature scaling, which harmonizes data scales and ensures no single data type disproportionately influences the AI's operations. Feature selection is another crucial phase, focusing on pinpointing the most relevant data attributes for the AI's learning process. This phase can leverage various techniques to determine the data's most critical aspects.

Once preprocessing is complete, the AI undergoes training. During this phase, the system repeatedly processes the data, refining its internal parameters for the best performance. After training, the AI is deployed to handle real-world data (i.e., greenhouse gas estimation). The AI can translate this data into a format it understands, utilizing the patterns it recognized during its training phase.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub combinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for measuring greenhouse gas emissions utilizing a telecommunications network, the system comprising:
one or more processors; and
one or more computer-readable media storing computer-usable instructions that, when executed by the one or more processors, cause the one or more processors to:
receive an indication that a user equipment (UE) has registered with a base station within the telecommunications network;
determine a velocity of the UE;
based on a determination that the UE's velocity is above a predetermined threshold, determine that the UE is traveling in a vehicle in a first location; and
estimate a total number of vehicles in the first location.

2. The system of claim 1, wherein the UE includes any equipment that uses a chip card and a chip.

3. The system of claim 1, wherein the predetermined threshold to determine a vehicle is in motion is 10 miles per hour.

4. The system of claim 1, wherein the UE's velocity is determined based on a handover time between the UE registering with the base station and subsequently registering with a second base station or utilizing accelerometric sensor data from the UE.

5. The system of claim 1, further comprising communicating vehicle information to the telecommunications network including a make and model of the vehicle.

6. The system of claim 1, wherein the one or more processors is further configured to communicate vehicle information to a data storage to maintain and store the vehicle information.

7. The system of claim 1, wherein the one or more processors is further configured to estimate greenhouse gas emissions for the first location based on the total number of vehicles.

8. A method for measuring greenhouse gas emissions utilizing a telecommunications network, the method comprising:
identifying a plurality of user equipment (UE) devices moving at a velocity above a predetermined threshold;
based on the velocity above a predetermined threshold, determining that the plurality of UE devices is moving in a vehicle;
determining a total number of vehicles at a first location based on analyzing one or more occupancy criteria, wherein the one or more occupancy criteria comprises a velocity for each UE device of the plurality of UE devices; and
based on the total number of vehicles, estimating greenhouse gas emissions for the first location.

9. The method of claim 8, wherein the UE is a vehicle with a SIM card.

10. The method of claim 8, wherein the UE is a mobile device connected to a vehicle.

11. The method of claim 8, wherein the predetermined threshold is 10 miles per hour.

12. The method of claim 8, further comprising communicating vehicle information to the telecommunications network including a make and model of each vehicle, the velocity of each the UE devices, and a location of each of the UE devices.

13. The method of claim 12, wherein the occupancy criteria further comprises a distance between each UE device.

14. The method of claim 13, further comprising creating a visual depiction of greenhouse gases in the first location.

15. A system for measuring greenhouse gas emissions utilizing a telecommunications network, the system comprising:
one or more processors; and
one or more computer-readable media storing computer-usable instructions that, when executed by the one or more processors, cause the one or more processors to:
identify a plurality of user equipment (UE) devices moving at a velocity above a predetermined threshold;
based on the velocity above a predetermined threshold, determine that the plurality of UE devices is moving in a vehicle;
determine a total number of vehicles at a first location based on analyzing one or more occupancy criteria, wherein the one or more occupancy criteria comprises a velocity for each UE device of the plurality of UE devices; and
based on the total number of vehicles, estimate greenhouse gas emissions for the first location.

16. The system of claim 15, wherein the UE is a vehicle with a SIM card.

17. The system of claim 15, wherein the UE is a mobile device connected to a vehicle.

18. The system of claim 15, wherein the predetermined threshold is 10 miles per hour.

19. The system of claim 15, further comprising communicating vehicle information to the telecommunications network including a make and model of each vehicle, the velocity of each the UE devices, and a location of each of the UE devices.

20. The system of claim 19, wherein the occupancy criteria further comprises a distance between each UE device.
